(19) United States
(12) Patent Application Publication
(10) Pub. No.: US 2024/0066340 A1
(43) Pub. Date: Feb. 29, 2024

(54) FIRE-FIGHTING DEVICE INCLUDING A DISTRIBUTED CONTROL SYSTEM

(71) Applicant: Hale Products, Inc., Ocala, FL (US)

(72) Inventors: Michael A. Laskaris, Collegeville, PA (US); Jason Cerrano, Lake St. Louis, MO (US)

(21) Appl. No.: 18/455,986

(22) Filed: Aug. 25, 2023

Related U.S. Application Data
(60) Provisional application No. 63/373,516, filed on Aug. 25, 2022.

(51) Int. Cl. A62C 37/36; A62C 31/00

(52) U.S. Cl. CPC A62C 37/36; A62C 31/005

(57) ABSTRACT

A fire-fighting system includes a pump, a nozzle for directing fluid flow from the pump, a nozzle component including a first transceiver and an indicator, a fluid line connecting the pump to the nozzle, and a discharge valve control assembly. The discharge valve control assembly includes a discharge valve controlling fluid flow between the pump and the nozzle, a pressure sensor coupled to the fluid line between the pump and the discharge valve, and a second transceiver providing communication between the nozzle component and the discharge valve control assembly. The discharge valve control assembly is configured to receive a request to charge a hose section of the fluid line and determine whether to open the discharge valve in response to receiving the request based on a fluid pressure detected by the pressure sensor.

### CROSS REFERENCE TO RELATED APPLICATIONS

This application claims priority to U.S. Provisional Patent Application No. 63/373,516, filed Aug. 25, 2022, the disclosure of which is incorporated herein by reference in its entirety.

### BACKGROUND

The present disclosure relates generally to control systems and, more specifically, to control systems for use in controlling a fire-fighting device.

Fire-fighting pumper trucks (broadly referred to herein as a “fire-fighting device”) are used to fight fires by pumping fluid (e.g., water, foam, or another flame retardant) from a source through hose lines wherein the fluid may be directed (i.e., sprayed) on a fire to facilitate extinguishing or containing the fire. Known pumper trucks include control systems used to regulate the operation of the truck and to control the flow of fluid from the truck into the hose lines. Such control systems generally include a plurality of valves used to control the flow of fluid to a fire pump from a storage tank transported onboard the truck or from another fluid supply source (e.g., a fire hydrant). The valves also facilitate control of the flow of fluid from the fire pump to fire hoses or other discharge devices. Known control systems include pressure and flow rate sensors used to monitor the pressure and flow rate of fluid at various locations within the pumper truck. For example, pressure sensors may monitor the pressure of the fluid received by the fire pump from the supply source. Generally, the pumper truck controls used to regulate the valves and the fire pump are commonly positioned in a control panel on the side of the pumper truck.

In traditional pumper trucks, during use, an operator, typically referred to as an engineer, must manually operate the controls of the pumper truck. More specifically, the engineer manually manipulates the controls to alter the flow rate and/or to control the pressure of liquid output by the pumper truck to a hose. Moreover, during operation, a firefighter positioned near a nozzle of the hose coupled to the pumper truck verbally communicates to the engineer (typically via a hand-held radio) any desired changes in the flow rate and/or pressure of liquid delivered through the hose to the nozzle. In response, the engineer manually adjusts the controls to enable the desired change in the flow rate and/or pressure of liquid delivered through the hose to be achieved. It is common for one engineer to be responsible for monitoring and responding to communications from multiple firefighters that each have a separate hose coupled to the same pumper truck.

In some known fire-fighting systems, an automated control system may be used to automatically control at least some of the operations traditionally handled by the operator. Known systems utilize one or more controllers which may be linked in communication with fluid control components, such as discharge valves and/or a pump of the fire-fighting device. However, such systems are generally complex to install and can require replacement of several functioning components on pre-existing manufactured trucks. As a result, such systems may be expensive to install onto pre-existing trucks. As used herein, the term “engineer” refers to a firefighter generally positioned at a firefighting device whose role relates to controlling operation of the firefighting device. As used herein, the term “nozzleman” generally refers to a firefighter whose role is to control and/or operate a nozzle of the firefighting device to direct fluid flow to target area. As used herein, the term “charge” or “charging”, when used in relation to a hose line or nozzle, refers to providing pressurized fluid to the hose line and or nozzle.

### BRIEF DESCRIPTION

In one aspect, a fire-fighting system is provided. The fire-fighting system includes a pump, a nozzle for directing fluid flow from the pump towards a target area, a nozzle component coupled to the nozzle, the nozzle component comprising a first transceiver and an indicator, a fluid line connecting the pump to the nozzle, and a discharge valve control assembly. The discharge valve control assembly includes a discharge valve controlling fluid flow between the pump and the nozzle, a pressure sensor coupled to the fluid line between the pump and the discharge valve, and a second transceiver providing communication between the nozzle component and the discharge valve control assembly. The discharge valve control assembly is configured to receive a request to charge a hose section of the fluid line and determine whether to open the discharge valve in response to receiving the request based on a fluid pressure detected by the pressure sensor.

In another aspect, a discharge valve control assembly for use with a fire-fighting system is provided. The discharge valve control assembly includes a discharge valve controlling fluid flow through a fluid line extending from a pump to a nozzle of the fire-fighting system, a pressure sensor coupled to the fluid line upstream of the discharge valve, and a transceiver providing communication with a nozzle component coupled to the nozzle. The discharge valve control assembly is configured to receive a request from the nozzle component to charge a hose section of the fluid line and determine whether to open the discharge valve in response to receiving the request based on a fluid pressure detected by the pressure sensor.

In yet another aspect, A method of operating a fire-fighting system is provided. The method includes transmitting a first signal from a transceiver at a firetruck of the fire-fighting system to a nozzle component indicating that a hose section of a fluid line is ready to be charged and receiving a second signal at the transceiver from the nozzle component, the second signal including a request to charge the hose section. The method further includes determining to charge the fluid line based on a fluid pressure detected by a pressure sensor and a predefined minimum pressure stored on a memory, the pressure sensor being positioned on the fluid line upstream of a discharge valve and automatically controlling, in response to the determining, the discharge valve to open to charge the hose section.

### BRIEF DESCRIPTION OF THE DRAWINGS

FIG. 1 is a schematic of an exemplary fire-fighting system.

FIG. 2 is a schematic of a control system of the fire-fighting system shown in FIG. 1.

FIG. 3 is a schematic of a communication network for use with the control system of FIG. 2.

FIG. 4 is a schematic of an alternative communication network for use with the control system of FIG. 2.

FIG. 5 is a schematic of an alternative fire-fighting system.

FIG. 6 is a schematic of an alternative control system of the fire-fighting system shown in FIG. 5.

FIG. 7 is a schematic of another alternative fire-fighting system.

FIG. 8 is a flow diagram of an exemplary method of operating the fire-fighting systems shown in FIGS. 1, 5, and 7.

### DETAILED DESCRIPTION

The exemplary systems and methods described herein overcome disadvantages of known fire-fighting control systems by enabling at least a partially automated control of components of a fire-fighting system. For example, some embodiments described herein include systems which may be retrofitted onto non-automated fire-fighting trucks, allow for pressure control at a remote nozzle of the fire-fighting system, and/or notify the fire-fighters at respective nozzles (“attack crew” or “nozzlemen”) if there is insufficient fluid pressure at the truck to charge their respective lines. As a result, the systems and methods described herein facilitate increasing the efficiency of the fire-fighting system in a cost-effective and reliable manner, while also improving firefighter safety by reducing the potential for human error.

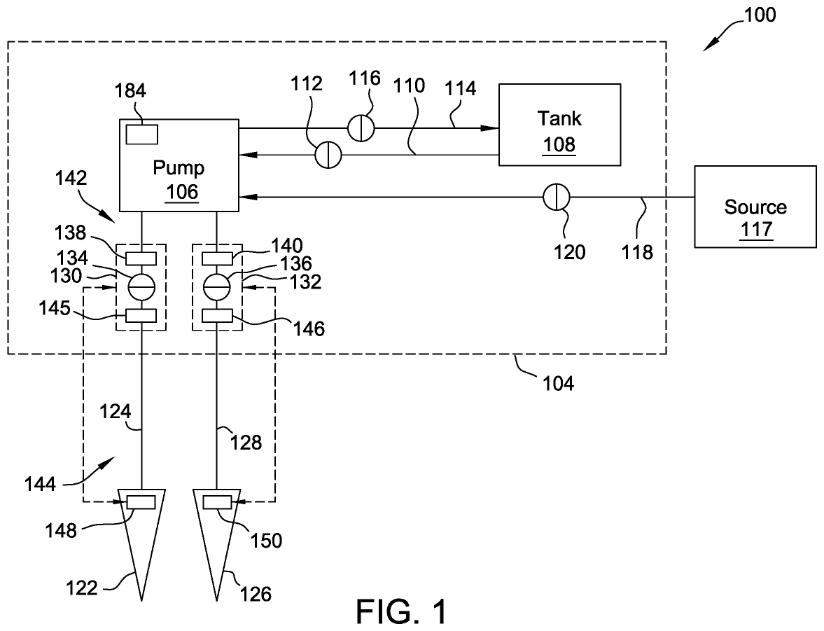

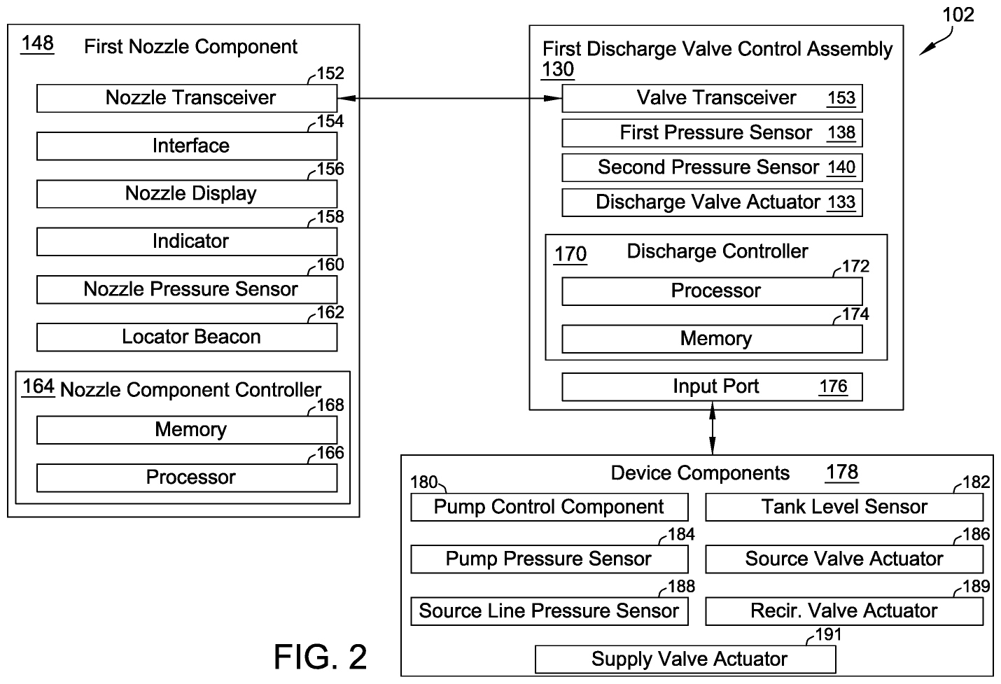

FIG. 1 is a schematic view of an exemplary fire-fighting system 100. FIG. 2 is a schematic of a control system 102 of the fire-fighting system 100 shown in FIG. 1.

In the exemplary embodiment, fire-fighting system 100 includes a fire-fighting device 104, such as a fire truck. A pump 106 and a tank 108 are coupled to fire-fighting device 104. Fluid for fighting or suppressing a fire is stored in tank 108. Tank 108 is coupled via a tank supply line 110 to pump 106 to enable fluid to be selectively supplied to pump 106. A tank supply valve 112 coupled to tank supply line 110 provides control of a flow of fluid from tank 108 to pump 106. A tank recirculation line 114 enables fluid to be re-circulated from pump 106 to tank 108. A tank recirculation valve 116 coupled to tank recirculation line 114 provides control of a flow of fluid from pump 106 to tank 108. In the embodiment of FIG. 1, the tank 108 recirculation line 114 is also used for filling the tank 108 with fluid from a fluid source 117. In other embodiments, fire-fighting device 104 may include separate recirculation and fill lines extending from pump 106 to tank 108, wherein each of the tank 108 and fill lines has its own selectively controllable valve thereon. In further embodiments, fire-fighting system 100 may not include the recirculation line 114 and recirculation valve 116.

A fluid source 117 is coupled to pump 106 via a source line 118. A source valve 120 is coupled to source line 118 to facilitate control of the flow of fluid from fluid source 117 to pump 106. In some embodiments, a pressure sensor (not shown) is coupled to source line 118 (e.g., at an intake manifold of fire-fighting device 104) to measure an operating pressure of fluid in source line 118. In the exemplary embodiment, the fluid discharged from fluid source 117 is water. In other embodiments, the fluid discharged from source 117 may be any other fluid such as, but not limited to, a foam-like substance or any other flame-retardant fluid. In the exemplary embodiment, fluid source 117 is a continuous fluid source 117 embodied as a fire hydrant. In other embodiments, fluid source 117 may be any other source of fluid, such as a river, lake, or any other body of water. In the exemplary embodiment, pump 106 is operable to selectively fill tank 108 with fluid from fluid source 117 using the tank recirculation valve 116 and/or fill valve (not shown) coupled to the tank 108.

A first nozzle 122 is coupled to pump 106 by a first fluid line 124, and a second nozzle 126 is coupled to pump 106 by a second fluid line 128. First and second nozzle 122, 126 may be carried by, and/or selectively positioned by, nozzlemen. Pump 106 is operable to receive fluid from either one of source line 118 and tank supply line 110, pressurize the fluid, and provide the pressurized fluid to first and second fluid lines 124, 128 and to first and second nozzle 122, 126 for discharge from the nozzles 122, 126 during a fire-fighting operation. Although only two fluid lines 124, 128 are illustrated in FIG. 1, it should be understood that in other embodiments, more or less than two fluid lines and associated valves, nozzles 122, 126, and pressure sensors may be used.

Although illustrated as single lines in FIG. 1, it should be understood that source line 118, tank supply line 110, tank recirculation line 114, and first and second fluid line 124, 128 may include separate lines, manifolds, or other intervening structures coupled therebetween. For example, source valve 120 and/or a pressure sensor (not shown) on source line 118 may be provided on an intake manifold of fire-fighting device 104 that is fluidly coupled between source 117 and pump 106. Additionally, first fluid line 124 and second fluid line 128 may be coupled to pump 106 through a discharge manifold (not shown), which may include features of the first and second fluid line 124, 128 as described herein.

In the exemplary embodiment, a first discharge valve control assembly 130 is coupled to first fluid line 124, and a second discharge valve control assembly 132 is coupled to second fluid line 128. The first and second discharge valve control assemblies 130, 132 are substantially the same except as described differently herein. The discharge valve control assemblies 130, 132 each include a discharge valve 134, 136 and a pressure sensor 138, 140. The discharge valves 134, 136 are selectively transitionable between an open state and a closed state for controlling a flow of fluid from pump 106 to the corresponding nozzles 122, 126. In particular, the discharge valve control assemblies 130, 132 are each coupled to a discharge manifold (not shown) of the fire-fighting device 104. The pump 106 supplies fluid at a uniform fluid pressure to the discharge manifold, which is then provided to each of the discharge valves 134, 136.

The fluid lines 124, 128 each include a first section 142 that extends from the pump 106 to a corresponding one of the discharge valves 134, 136, or alternatively, a discharge manifold (not shown). The first sections 142 of the fluid lines 124, 128 are positioned generally internally within the fire-fighting device 104. The fluid lines 124, 128 also include a second section 144 (also referred to herein as “hose lines” or “hose sections”). The second sections 144 each extend from the discharge valves 134, 136 to the corresponding nozzles 122, 126 and are positioned substantially external to the fire-fighting device 104. In the exemplary embodiment, the discharge valves 134, 136 are exposed on an exterior of the fire-fighting device 104 and the hose lines 144 are coupled to corresponding discharge valves 134, 136. In other embodiments, discharge valves 134, 136 may be at least partially positioned within an interior of fire-fighting device 104.

The first and second pressure sensors 138, 140 are coupled to the first and second hose line 124, 128, respectively, upstream from the corresponding discharge valves 134, 136 to enable an operating pressure of fluid flowing from pump 106 to the discharge valve to be measured. In particular, as described herein, the first and second pressure sensors 138, 140 enable fluid pressure ready to be provided to the hose lines 144 to be checked, prior to the lines hose lines 144 being charged. That is, the first and second pressure sensors 138, 140 each measure an operating pressure of fluid provided by pump 106 even when discharge valves 134, 136 are in a closed state. In other embodiments where a fluid pressure check prior to charging is unnecessary, for example, such as in embodiments where the control system 102 is configured to control the pump 106 in response to a charging request from the nozzlemen, as described in greater detail below, first and second pressure sensors 138, 140 upstream from discharge valves 134, 136 may not be included in fire-fighting device 104. In further embodiments, the upstream first and second pressure sensors 138, 140 may be provided as a single pressure sensor coupled between the pump 106 and discharge valves 134, 136 or discharge manifold (not shown).

Third and fourth pressure sensors 145, 146 are downstream from discharge valves 134, 136 for measuring fluid pressures in respective hose lines 144 after hose lines 144 have been charged. Although the pressure sensors 138, 140, 145, 146 are shown as separate components from discharge valves 134, 136 in the embodiment of FIG. 1, in other embodiments, pressure sensors 138, 140, 145, 146 may be coupled to and/or integrated with corresponding discharge valves 134, 136 to measure fluid pressure within the discharge valves 134, 136. In the exemplary embodiment, pressure sensors 145, 140, 145, 146 are each transducers. In alternative embodiments pressure sensors 138, 140, 145, 146 may each measure flow rates of fluid in system. In further alternative embodiments, pressure sensors 138, 140, 145, 146 may be any sensor that enables system to function as described herein.

In some embodiments, discharge valve control assemblies 130, 132, or at least portions of discharge valve control assemblies 130, 132, are removably coupled to fire-fighting device 104 to enable retrofitting fluid control system 102 on pre-existing fire-fighting devices 104. In further embodiments, an additional pressure sensor (not shown) may be provided on first hose line 124 and/or first nozzle 122 to measure an operating pressure of fluid at first nozzle 122.

In the exemplary embodiment, a first nozzle component 148 is coupled to first nozzle 122 and a second nozzle component 150 is coupled to second nozzle 126. As described in greater detail below with respect to FIG. 2, nozzle components 148, 150 are each in wireless communication with a respective one of the discharge valve control assemblies 130, 132 for providing information to a nozzleman during use, and for relaying commands from the nozzleman to fire-fighting device 104. In some embodiments, the nozzle components 148, 150 are paired with discharge valve control assemblies 130, 132. In other embodiments communications between nozzle components 148, 150 and discharge valve control assemblies 130, 132 may be routed through an additional communications component such as a radio (not shown in FIG. 1). First and second nozzle components 148, 150 are substantially identical, except that each nozzle component 148,150 is wirelessly paired with a different corresponding discharge valve control assembly 130, 132 of fire-fighting device 104.

Referring to FIG. 2, in the exemplary embodiment, first nozzle component 148 includes a nozzle transceiver 152, and optionally further includes any of an interface 154, a nozzle display 156, an indicator 158, a nozzle pressure sensor 160, or a locator beacon 162.

Interface 154 receives inputs from a nozzleman operating the nozzle 122 (shown in FIG. 1), such as, but not limited to, a request for charging, and/or a request for a specific fluid pressure at the nozzle 122, and/or a request to increase or decrease the pressure on the hose line 144 (shown in FIG. 1) incrementally. Suitable interfaces 154 may include, but are not limited to only including, a pushbutton, switch, touchscreen or a twistable collar.

Nozzle display 156 may display, or audibly communicate, one or more operating parameters of fire-fighting device 104 such as tank level, source fluid pressure, and/or a pressure at the nozzle, etc. An indicator 158 provide an audible, visual, and/or haptic indicator to the nozzleman indicating that the corresponding hose line 144 (shown in FIG. 1) is charged and/or is ready to be charged. In other embodiments, the indicator 158 may be provided by the nozzle display 156. Nozzle pressure sensor 160 detects a pressure of fluid at the nozzle 122 (shown in FIG. 1). Locator beacon 162 is provides an audible and/or visual locator at the nozzle 122 used to identify the nozzle 122 from a distance away, and potentially in smoke filled conditions. Nozzle transceiver 152 is communicatively coupled to, or “wirelessly linked” with a corresponding valve transceiver 153 of first discharge valve control assembly 130. First nozzle component 148 also includes a nozzle component controller 164 including a processor 166 and a memory 168 that stores instructions thereon in communication with the memory 168.

Although nozzle components 148, 150 are shown coupled to nozzles 122, 126 in FIG. 1, it should be understood that nozzle components 148, 150 and/or portions of nozzle components 148, 150 need not necessarily be integrated with the nozzles 122, 126 and may instead be provided at any point along hose lines 144 between the discharge valves 134, 136 and fluid outlets of the nozzles 122, 126. For example, in some embodiments, the nozzle transceiver 152, nozzle pressure sensor 160, indicator 158, interface 154, locator beacon 162, and/or nozzle component controller 164 may be provided as separate component from the nozzle 122 that is coupled to hose lines 144 upstream from the respective nozzles 122, 126, such as at an inlet (not shown) of the nozzles 122, 126.

In the exemplary embodiment, first discharge valve control assembly 130 further includes a discharge controller 170 including a processor 172 and a memory 174 storing instructions thereon. First discharge valve control assembly 130 further includes a system input port 176 for providing communication between the discharge valve control assembly 130 and device components 178 of the fire-fighting device 104 (shown in FIG. 1). Exemplary device components 178 may include a pump control component 180, a tank level sensor 182 for measuring a volume level of tank 108 (shown in FIG. 1), a pump pressure sensor 184, and/or a source line pressure sensor 188. The device components 178 may also include a source valve actuator 186 that actuates the source valve 120, a recirculation valve actuator 189 that actuates recirculation valve 116, and a supply valve actuator 191 that actuates the supply valve 116, shown in FIG. 1. In other embodiments, first discharge valve control assembly 130 may be communicatively coupled to device components 178 of fire-fighting device 104 via any suitable wireless and/or wired communication system that enables control system 102 to function herein. For example, in some embodiments, fire-fighting device 104 may include a Controller Area Network (“CAN”) that provides communication between first discharge valve control assembly 130 and at least one or more of device components 178.

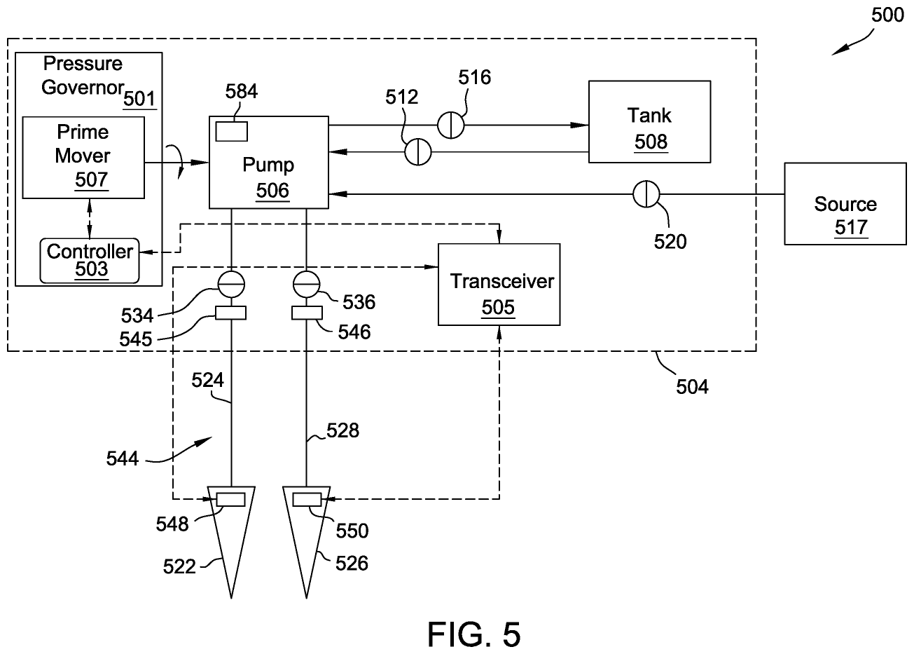

Pump control component 180 may include a component (not shown) operable to adjust an operating state of the pump 106 and to thus adjust the pressure of fluid provided to hose lines 144. In the exemplary embodiment, operation of pump 106 is controlled manually (e.g., by an engineer at a control panel of fire-fighting device 104). For example, the controls for the pump 106 may be provided on an interface of a pressure governor (not shown) or at a separate control panel of fire-fighting device 104. Additionally, when operation of the pump 106 is controlled manually, pump control component 180 may include an indicator (not shown) on the fire-fighting device 104 that signals the engineer to manually adjust operation of the pump 106. In other embodiments, control system 102 may be configured to control pump 106 automatically based on inputs control system 102, such as messages received from nozzlemen at nozzle components 148, 150. For example, and without limitation, in some embodiments, the pump control component 180 is a pressure governor that includes a controller in communication with a prime mover (e.g., as shown in the embodiment of FIG. 5). In such embodiments, the controller may automatically control operation of the pump 106 based on signals received from discharge valve control assemblies 130, 132 or other inputs of control system 102. In further embodiments, the pump 106 may be automatically controlled, with manual controls provided as an override to the automated control.

In other embodiments, first nozzle component 148 may not include nozzle component controller 164 and/or first discharge valve control assembly 130 may not include discharge controller 170. Moreover, in other embodiments, functions described herein as being performed by either one of nozzle component controller 164 and/or discharge controller 170 may be performed by a single controller or multiple controllers.

In the exemplary embodiment, the nozzle components 148, 150 and/or the discharge valve control assemblies 130, 132, together with the device components 178, collectively define control system 102 of fire-fighting device 104 for facilitating at least partially automated control of fluid flow within fire-fighting system 100. As an example, fire-fighting system 100 may automatically control operation of the pump 106 and/or a position of actuation state of discharge valves 134, 136 based on fluid pressure, as measured by the pressure sensors 138, 140, 145, 146, in the lines 144 and/or a request for a line charge received at the nozzle component 148. Such automated controls provide confirmation that fluid provided by the pump 106 is at a pressure sufficient to proceed with charging of the hose lines 144, thus preventing charging the lines 144 when fluid pressure provided by the pump 106 is below a minimum threshold. For example, upon arriving on a scene, fire-fighters may deploy each of the nozzles 122, 126 and request charging of their respective line(s) when they are in an attack position. In embodiments where pump 106 is not automatically controlled, such as illustrated in FIG. 1, the engineer may operate the pump 106 to provide a specified fluid to each of the lines. The requests for pressure may be input at the nozzle component 148, such as, for example, by interface 154 (e.g., a pushbutton, switch, touchscreen, etc.) provided on the nozzle component 148 and/or by other controls (not shown) provided at the fire-fighting device 104. Additionally, discharge valve control assemblies 130, 132 may prevent charging of a respective line (e.g., by maintaining the corresponding discharge valves 134, 136 closed) until the associated pressure sensor(s) 138, 140 detects that a pressure in the respective lines exceeds the minimum pressure threshold necessary for charging the lines 144.

In the exemplary embodiment, if the discharge valve control assemblies 130, 132 detect that the pressure measured by the corresponding pressure sensor 138, 140 is equal to or exceeds the minimum pressure threshold, the discharge valve control assemblies 130, 132 may automatically open the respective discharge valves 134, 136 by controlling the corresponding discharge valve actuator 133 (e.g., in response to a request to charge the corresponding line) and/or may transmit a signal to the corresponding nozzle component 148 to cause the nozzle component 148 to indicate to the fire-fighter (e.g., using indicator 158) that the line is ready to charge and/or is charged. If the detected pressure is below the minimum pressure threshold, the discharge valve control assemblies 130, 132 may prevent charging of the lines (e.g., by keeping the discharge valves 134, 136 closed). Additionally, in response to detecting that the fluid pressure is below the minimum threshold, control system 102 may also provide a signal to the corresponding nozzle component 148 to indicate to the fire-fighter that the line is not yet ready to charge. Additionally or alternatively, if there is insufficient pressure detected to charge the line 144, the discharge valve control assembly 130 may notify an engineer at the fire-fighting device 104 (e.g., at a control panel) that there is inadequate pressure at the pump 106 to charge the lines. A low fluid pressure indicator 158 may include an audible or visual notification that is perceptible by the engineer. Alternatively, control system 102 may automatically transmit a signal to pump control component 180 that causes the pump control component 180 to automatically adjust an operating state of the pump 106 (e.g., by increasing pump 106 speed) to increase the fluid pressure.

In the exemplary embodiment, the minimum pressure thresholds for charging each of the lines 144 is stored in the memory 168 of discharge controller 170. Different thresholds may be provided for each discharge valve control assembly 130 and/or for each different nozzle component 148. In some embodiments, the pressures thresholds for each discharge valve control assembly 130 may be manually set by a user. In other embodiments, a machine learning algorithm may be used to adjust the minimum pressures over subsequent uses based on historic averages of the detected pressures in the lines 144 accumulated over time. By way of example, if friction losses within the system (e.g., within the hose lines 144) repeatedly result in a fluid pressure of 50 pounds per square inch (“psi”) at the nozzle 122 while the pump 106 is operating at a pump outlet pressure of 80 psi, to maintain 50 psi at the nozzle 122, the control system 102 would begin initializing or starting the initial charge at 80 psi, and then measuring the pressure at the nozzle 122, using the nozzle pressure sensor 160, and adjusting the pump speed accordingly. Hose lines 144 can be changed on trucks over time, and as such, the machine learning algorithm can adjust after just a few uses to a change in hose load. In some embodiments, the discharge valve control assemblies 130, 132 may further be communicatively connected to one or more components of the fire-fighting system 100 for relaying information for display at the corresponding nozzle component 148, 150. For example, in some such embodiments, discharge valve control assemblies 130, 132 may each include an input for receiving fluid levels at the tank 108 (e.g., as detected by the tank level sensor 182), pressure from the fluid source 117 (e.g., as detected by the source line pressure sensor 188), and/or any other suitable information.

In the exemplary embodiments, the discharge valve control assemblies 130, 132 are operable to move the discharge valves 134, 136 (e.g., by the discharge valve actuators 133) between an open state, a closed state, and a plurality of intermediate states between the open and closed states. The intermediate states may enable the fluid pressure (relative to the fully opened state) to be adjusted in the respective lines such that different pressure settings are provided at each of the nozzles 122, 126. For example, a nozzlemen at first nozzle 122 may request a different fluid pressure through interface 154, than a nozzleman at second nozzle 126. Thus, to enable varied pressure in one of the lines, the control system 102 may either increase the operating speed of the pump 106 and/or adjust a position of the corresponding discharge valve 134. In alternative embodiments, discharge valves 134, 136 may be positioned in either an open state or a closed state (i.e., without the ability to individually adjust fluid pressure in the lines via intermediate states of the valves). In some such embodiments, fire-fighting system 100 may include a central controller (not shown) that facilitates control of the actuation states of valves 134, 136 and control of the operation of the pump 106 based on the actuation states of the valves 134, 136. For example, in such embodiments, in response to receiving a request to open a discharge valve, the central controller (not shown) may transmit a signal to the pump control component 180 to increase operating speed of the pump 106 to maintain a consistent fluid pressure in the lines 124, 128.

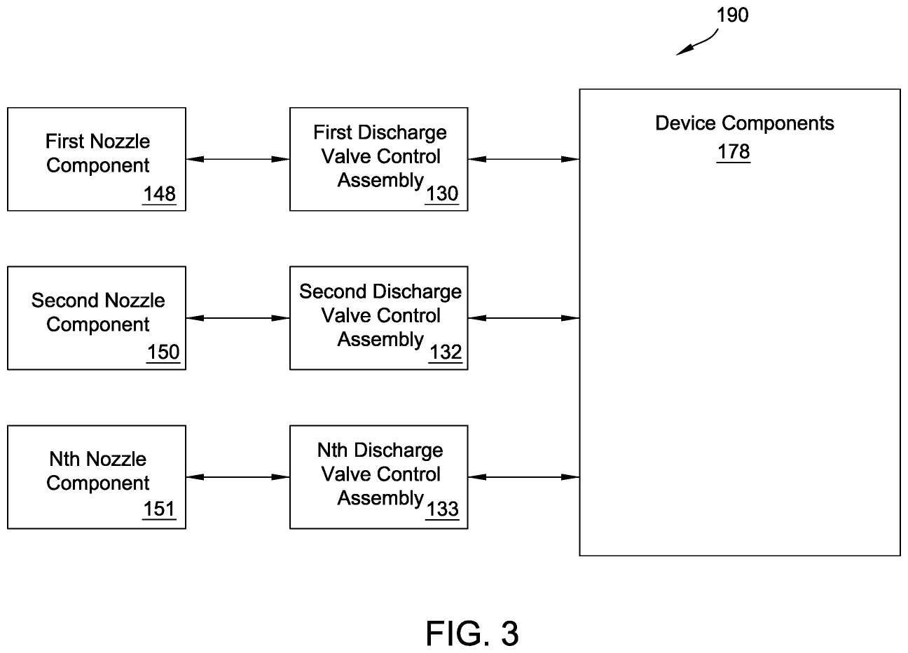

FIG. 3 is a schematic view of an exemplary communication network 190 that may be used with control system 102 shown in FIG. 2. In the exemplary embodiment, nozzle components 148, 150, 151 are in wireless communication with corresponding discharge valve control assemblies 130, 132, 133. Discharge valve control assemblies 130, 132, 133 are each coupled in communication individually with device components 178. In other embodiments, the communication network 190 may include a communications interface (not shown), such as a communication bus, router, or other suitable network interface, for distributing communication signals between discharge valve control assembly 130 and device components 178 of fire-fighting device 104. In such embodiments, discharge valve control assemblies 130, 132, 133 may each be individually coupled to the communications interface and the communications interface may be in communication with each of the device components 178.

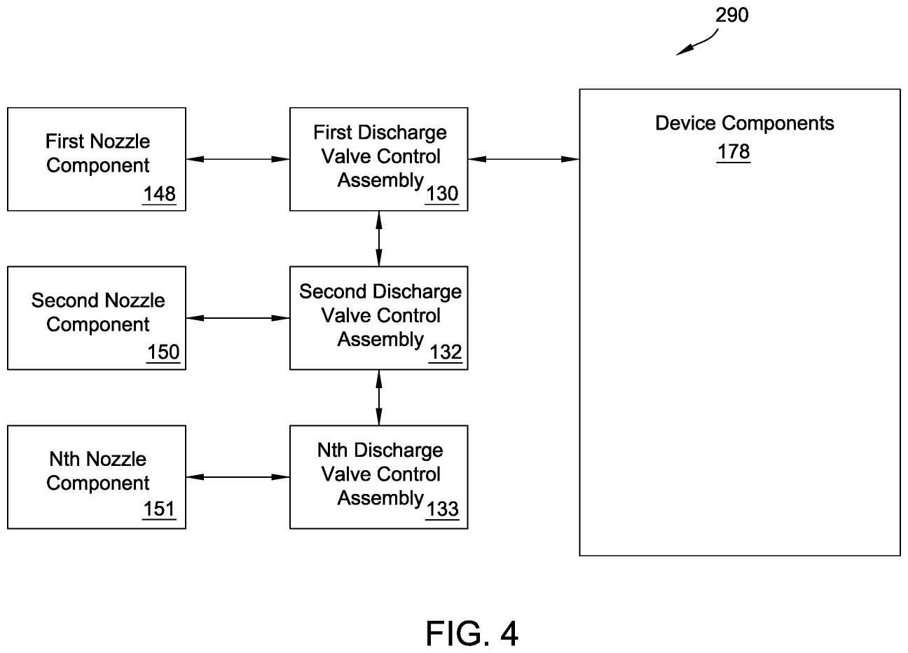

FIG. 4 is a schematic view of an alternative communications network 290 that may be used with control system 102 shown in FIG. 2. The communications network 290 of FIG. 4 is similar to the communications network 190 shown in FIG. 3 in that each of the nozzle components 148, 150 are coupled in communication with the corresponding discharge valve control assemblies 130, 132. However, in the embodiment of FIG. 4, not all discharge valve control assemblies 130, 132 are directly communicatively linked to device components 178. Rather, in the embodiment of FIG. 4, first discharge valve control assembly 130 is coupled directly in communication with device components 178, and other discharge valve control assemblies 132, 133 are coupled in a piggyback communication with first discharge valve control assembly 130. Specifically, communications between second discharge valve control assembly 132 and device components 178 are routed through first discharge valve control assembly 130. Communications between an “nth” discharge valve control assembly 133 and device components 178 are routed to the second discharge valve control assembly 132 and from the second discharge valve control assembly 132 to the first discharge valve control assembly 130. In such embodiments, discharge valve control assemblies 130, 132, 133 may be in wired and/or wireless communication. For example, in embodiments where discharge valve control assemblies 130, 132, 133 are linked in wireless communication, discharge valve control assemblies 130, 132 may form a wireless mesh network, in which one of the discharge valve control assemblies 130, 132, 133 (e.g., first discharge valve control assembly 130 in FIG. 4) functions as a master node and the remaining discharge valve control assemblies 132, 133 function as minor nodes for relaying communications with the master node.

In other embodiments, at least one of the discharge valve control assemblies 130, 132 may be in direct wireless communication with the master node first discharge valve control assembly 130. Moreover, in some embodiments, communications between discharge valve control assemblies 130, 132, 133 may be facilitated using CAN messaging of the fire-fighting device 104 in addition to or alternatively to other communications methods described herein. Additionally, in some embodiments, communications between device components 178 and first discharge valve control assembly 130 may be facilitated using the CAN messaging network of the truck. For example, and without limitation, in some embodiments, pressure measurements detected by the pressure sensors 138, 140, 145, 146 (shown in FIG. 1) and/or the level information from tank level sensor 182 (shown in FIG. 2) may be transmitted with CAN messaging provided by a manufacturer of the fire-fighting device 104.

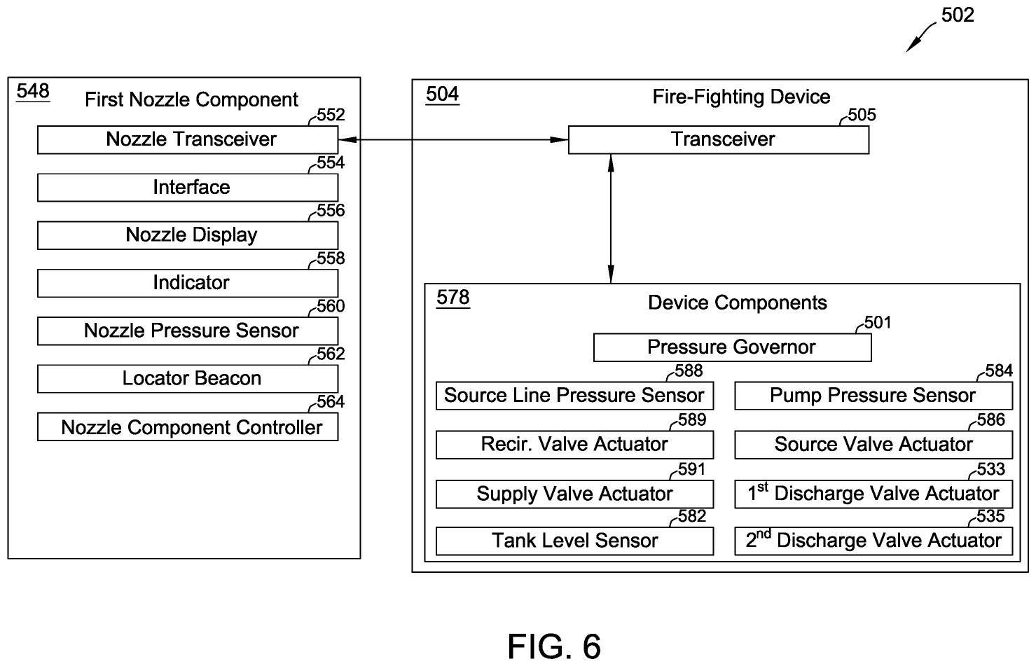

FIG. 5 is a schematic of an alternative fire-fighting system 500. FIG. 6 is a schematic of an alternative control system 502 that may be used with fire-fighting system 500 of FIG. 5.

Fire-fighting system 500 of FIG. 5 is substantially the same as fire-fighting system 100 shown in FIG. 1, except as described below. In particular, in the embodiment of FIG. 5, fire-fighting system 500 also includes a pressure governor 501 for controlling operation of pump 506. The pressure governor 501 includes a controller 503 that controls a prime mover 507. A transceiver 505 is coupled to the fire-fighting device 504 and is in communication with the pressure governor 501. In this embodiment, transceiver 505 may be provided with, or provided independently from fire-fighting device 504 and installed on pre-existing fire-fighting devices 504 (i.e., retrofit). In such embodiments, the transceiver 505 may be coupled in communication with one or more device components 578 of fire-fighting device 504 (e.g., via wired or wireless communication systems, such as a CAN), and may transmit data between the fire-fighting device 504 and the nozzles 522, 526 and/or may transmit control signals to the fire-fighting device 504 and/or to the nozzles 522, 526 based on data received from device components 578 (shown in FIG. 6) and/or nozzle components 548, 550. For example, in some embodiments, the transceiver 505 is in direct communication with each of the device components 578 and transmits command signals to the device components 578. In other embodiments, the transceiver 505 is in communication with one or more centralized controllers (not shown) of fire-fighting device 504, which receive signals from the transceiver 505 and which generate control instructions to each of the device components 578 based on signals received from the transceiver 505. The system 500 further includes a tank 508 and a source 517 that are the same as the tank 108 and source 117, shown in FIG. 1.

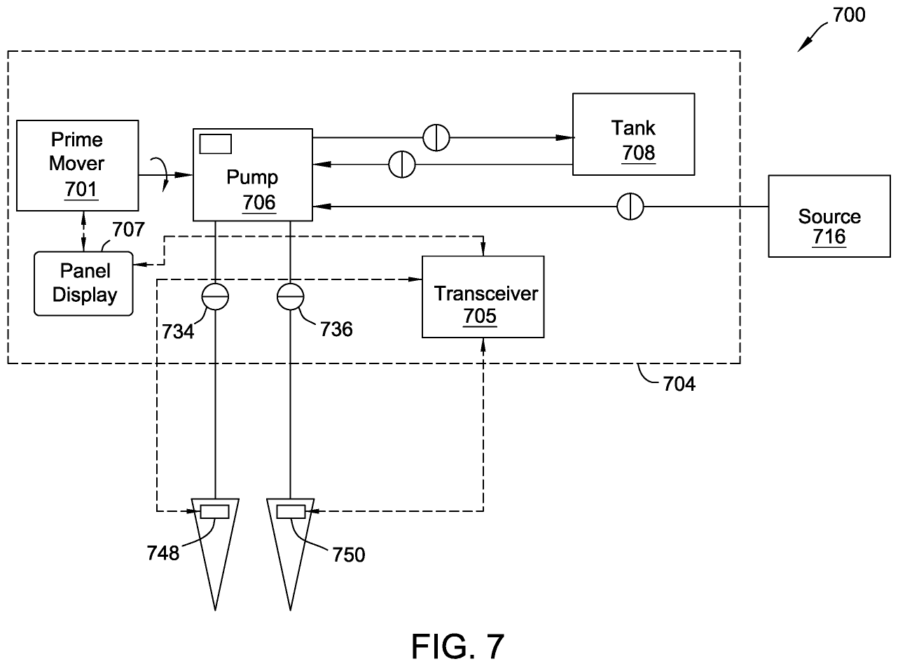

In some embodiments, the transceiver 505 may be integrated within a control loop of the fire-fighting device 504 (as illustrated in FIG. 5) such that components of the fire-fighting device 504 (e.g., prime mover 507, pump 506, valves 512, 516, 520, 534, 536, etc.) are automatically controlled based on data and/or signals received by the transceiver 505. In other embodiments, the transceiver 505 may not be integrated with, or may only be partially integrated within, the control loop of the fire-fighting device 504. In such embodiments, the fire-fighting device 504 may display data (e.g., nozzle pressure, nozzle flow rate, etc.) at a display (not shown) on the fire-fighting device 504, for example, to an operator or engineer who then manually adjusts components of the fire-fighting device 504 to achieve desired fluid parameters, as described in greater detail with respect to the embodiment of FIG. 7. Moreover, in some embodiments, the transceiver 505 may be sold in combination (e.g., as a kit or assembly) with one or more nozzles 522, 526 (e.g., first nozzle 522 and/or second nozzle 526) that are paired with the transceiver 505 and capable of transmitting data and/or control signals between the fire-fighting device 504 and the nozzles 522, 526.

In the exemplary embodiment, fire-fighting device 504 does not include discharge valve control assemblies 130, 132 (shown in FIG. 1) in communication with nozzle components 548, 550. Rather, in the exemplary embodiment, fire-fighting device 504 includes the transceiver 505 and nozzle components 548, 550 are each in wireless communication with transceiver 505. In alternative embodiments, fire-fighting device 504 may include discharge valve control assemblies 530, 532 that are substantially similar to the assemblies 130, 132 shown in FIG. 1, apart from the fact that they are in communication with the controller 503 and prime mover 507, as shown in FIG. 5.

In the exemplary embodiment, prime mover 507 controls operation of pump 506. For example, prime mover 507 may include a pump motor (not shown). Controller 503 receives signals from transceiver 505 and control prime mover 507, and thus operation of the pump 506, is based at least partially on signals received from transceiver 505. That is, in the exemplary embodiment, in contrast with the embodiment of FIG. 1, control system 502 is configured to automatically control pump 506 without manual control by an operator at the fire-fighting device 504.

Referring to FIG. 6, in the exemplary embodiment, first nozzle component 548 includes a transceiver 552 for providing communication between the first nozzle component 548 and transceiver 505 of fire-fighting device 504. Transceiver 505 of fire-fighting device 504 is also communicatively coupled with device components 578 of fire-fighting device 504. Device components 578 of FIG. 6 include similar device components 578 as those included in the embodiment illustrated in FIG. 3, including for example, pressure governor 501, pump pressure sensor 584, source line pressure sensor 588, source valve actuator 586, recirculation valve actuator 589, supply valve actuator 591, and tank level sensor 582. However, in the exemplary embodiment of FIG. 6, device components 578 in communication through transceiver 505 also include first discharge valve actuator 533 and second discharge valve actuator 535. The first nozzle component 548 may also include an interface 554, a nozzle display 556, an indicator 558, a nozzle pressure sensor 560, a locator beacon 562, and a nozzle component controller 564 that are substantially the same as described with respect to first nozzle component 148 (shown in FIG. 2).

In some embodiments, fire-fighting device transceiver 505 and/or device components 578 may include a communications interface, such as a communication bus, router, or other suitable network interface for distributing communication signals between fire-fighting device transceiver 505 and device components 578 of fire-fighting device 504. Communication between fire-fighting device transceiver 505 and device components 578 may be facilitated by individual inputs to transceiver 505, analog inputs, CAN messaging inputs, and/or wireless connections.

In some embodiments, fire-fighting device transceiver 505 is part of a controller (not shown) of fire-fighting device 504. In some such embodiments, the controller includes a processor and memory (not shown) and the controller monitors tank level based on readings from tank level sensor 582, monitors intake pressure from the truck based on readings from source line pressure sensor 588, monitors pressure in the pump 506 (e.g., outlet pressure) based on one or more pump pressure sensors 584, transmits or receive pressure requests from the pressure governor 501 to maintain varying pressures in the pump 506 needed to adequately pump the hose lines 544 at a safe pressure for the nozzles 522, 526, provides open and close signals to valve actuators 533, 535, 586, 589, 591 during operation and/or sets a position of valves to an intermediate state to control pressure in the respective lines based on pressures sensed by the pressure sensors 545, 546. Moreover, although the transceiver 505 is described as a single unit herein, in other embodiments, control system 502 may include multiple transceivers 505, controllers, and/or nodes on a network that collectively perform the functions of the fire-fighting device transceiver 505 as described herein.

In some embodiments, fire-fighting device transceiver 505 controls discharge valve actuators 533, 535 and/or pressure governor 501 based on actual pressures sensed at the nozzle and a user-requested fluid pressure at the corresponding nozzle. For example, a nozzleman may initially request charging of the hose line 544 using interface 554 at nozzle component 548. In response, nozzle transceiver 552 transmits a signal to fire-fighting device transceiver 505 indicating the request and fire-fighting device transceiver 505 may transmits a signal to the first discharge valve actuator 533 to open the first discharge valve 534, thus adjusting the valve 534 based on a predetermined starting pressure setting. When the hose line 544 of the first fluid line 524 is charged, nozzle pressure sensor 560 detects fluid pressure at the nozzle 522 and may transmit the detected pressure to transceiver 505. If there is a discrepancy (e.g., due to friction loss in the hose) between the predetermined pressure setting and the actual pressure sensed at the nozzle pressure sensor 560, transceiver 505 may adjust a position of the corresponding discharge valve 534 and/or operation of pump 506 (via pump control component 580) to facilitate reducing any difference between the pressure setting and the sensed pressure. The transceiver 505 may also learn over time if more pressure is consistently needed and may then adjust the initial starting pressure setting based on data from historic averages of use. Additionally, control system 102 of FIG. 2 may also adjust settings of the corresponding discharge valves 134, 136 and/or pump 106 to provide a desired fluid pressure at a nozzle 122, 126 in substantially the same manner as described with respect to FIG. 6.

FIG. 7 is a schematic of another alternative fire-fighting system 700. Fire-fighting system 700 of FIG. 7 is substantially the same as fire-fighting system 500 of FIG. 5, except as described below. In particular, in the embodiment of FIG. 7, fire-fighting device 704 includes a panel display 707 in communication with the transceiver 505. Panel display 707 may communicate visual and/or audio format information provided by the transceiver 705 and received from nozzle components 748, 750 and/or other device components, such as device components 578 (shown in FIG. 6) of fire-fighting device 504.

During operation, the engineer may control operation of the pump 706, discharge valves 734, 736, and/or any device components 778 of fire-fighting device 704 based on information displayed on panel display 707. For example, the panel display 707 may display fluid pressures detected by pressure sensors at each of the nozzle components 748, 750 and the engineer may manually adjust control of the pump 706 or other device components, such as device components 578 (shown in FIG. 6) based on the detected fluid pressures. In some embodiments, the panel display 707 includes an operator interface for receiving controls from the engineer. In other embodiments, the fire-fighting device 704 includes a control panel (not shown) that is separate from the panel display 707.

In other embodiments, the fire-fighting device 104 of FIG. 1 may also include a panel display 707 that operates in substantially the same manner as the panel display 707 described with respect to FIG. 7, except that it is in communication with the discharge valve control assemblies 130, 132 of FIG. 1.

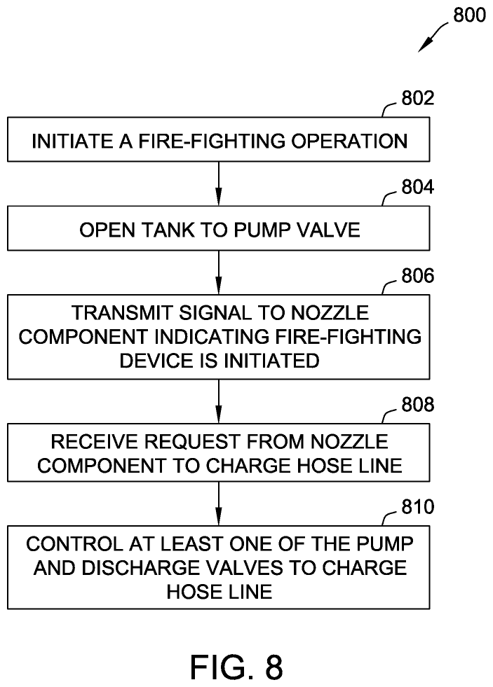

FIG. 8 is a flow diagram of an exemplary method 800 of operating a fire-fighting system. The method may be performed using any one of the fire-fighting systems 100, 500, 700 of FIGS. 1, 5, and 7 and the respective control systems 202, 502 of FIG. 2 or 6. In some embodiments, the method of FIG. 8 provides for a quick attack fire-fighting method, in which the nozzlemen may deploy to attack positions, request fluid, and begin discharge from their respective nozzles 122, 126, without any intervention or control required by an operator at the fire-fighting device 104, such as described with respect to the embodiment of FIG. 5.

In the exemplary method, initially, upon arriving on a scene (e.g., a fire scene), control system 102 initiates a fire-fighting operation 802. In some embodiments, control system 102 may automatically determine to initiate the fire-fighting operation 802 in response to detecting a change in state of operation of fire-fighting device 104. For example, in some such embodiments where fire-fighting device 104 is a firetruck, control system 102 may initiate the fire-fighting operation 802 when the system detects that the vehicle shifted between park and drive gears, or that the vehicle has shifted into another gear commonly used for fire-fighting operations.

In response to the fire-fighting operation being initiated 802, control system 102 opens tank supply valve 116 (shown in FIG. 1) 804 to allow flow of fluid from tank 108 to pump 106. In some embodiments, referring to FIG. 1, recirculation valve 116 is also automatically opened to bleed any residual air in the pump 106 out of the pump 106 and to provide cooling for the pump 106 during operation. In other embodiments, residual air may be bled from the pump 106 and the pump 106 may be cooled using any valve/line, such as a tank fill valve (not shown), or by using a smaller solenoid controlled valve like a pump cooler line (not shown) separate from the tank fill valve.

In the exemplary method, after the supply valve 116 is opened 804, control system 102 provides a signal 806 to nozzle components 148, 150 indicating that fire-fighting device 104 is ready to receive requests for water at the nozzles 122, 126 (i.e., that the respective hose lines 144 are ready to be charged). In some embodiments, prior to providing the indication that the lines 144 are ready to be charged 808, control system 102 may first initiate operation of the pump 106 and perform a pressure check (e.g., as described above with respect to FIGS. 1 and 2) to determine whether the predetermined fluid pressure has been generated by the pump 106. The check may be particularly suitable for embodiments where pressure in the pump 106 is controlled and maintained manually (e.g., by an engineer). In other embodiments, control system 102 automatically adjusts control of pump 106 and discharge valves 134, 136. In some such embodiments, performing the pressure check prior to signaling to nozzlemen that the lines 144 are ready to charge may not be necessary, since the pump 106 and valves 134, 136 may be controlled to provide at least the minimum or starting fluid pressure to the lines 144 in response to receiving a request for the lines 144 to be charged from nozzlemen at the nozzle components 148, 150.

In the exemplary method, control system 102 receives a request 808 from at least one of the nozzle components 148, 150 to charge the corresponding line 144. In some embodiments, the request for charging of the lines 144 may include a user-requested fluid pressure to be provided in the line. In other embodiments, a predetermined starting fluid pressure setting may be determined for all or a plurality of nozzle components 148, 150. In other embodiments, each nozzle component 148, 150 may have an initial pressure setting that is specific to the nozzle 122, 126.

In the exemplary method, control system 102 controls operation 810 of pump 106 and/or discharge valves 134, 136 to provide fluid to the nozzles 122, 126 at the starting fluid pressure setting. In embodiments where the pressure settings are different among the nozzles 122, 126, pump 106 is controlled 810 to provide the highest pressure setting of the different nozzle components 148, 150. Control system 102 is further configured to provide closed loop updates to control of pump 106 and/or discharge valve based on the detected fluid pressure measured at the nozzle pressure sensor 160s.

In the exemplary system, control system 102 may also prevent an engineer from manually adjusting pump 106 controls to reduce the pressure setting below the determined fluid pressure settings for each hose line and nozzle component. For example, where a nozzleman has requested a fluid pressure of 60 psi at their nozzle component, control system 102 controls operation of pump 106 and the discharge valves 134, 136 to provide fluid to corresponding nozzle at 60 psi. If the engineer at the fire-fighting device 104 adjusts pump 106 controls in a manner that would limit the pump 106 to be able to provide only 55 psi to the corresponding nozzle, control system 102 may reject or prevent the adjustment made by the engineer and provide an error message to the engineer, notifying them that they are making an unsafe adjustment. If a change in the fire-fighting system 100 causes the system to operate below the determined fluid pressure setting (e.g., such as a change in the source pressure or tank 108), the control system 102 may provide audible, visual, and/or haptic alerts, for example, to the engineer that lines are under pressurized. If the system 102 noticed a complete loss of intake pressure and the tank supply valve 116 was closed, the system 102 could open the tank supply valve 116 and resume flow while alerting the operator to close the source valve 120. If the tank supply valve 116 was closed and the system 102 was achieving significant discharge pressure, the system 102 could assume a draft condition (i.e., a condition in which the pump 106 generates a negative pressure differential within the source line 118). Should the system lose discharge pressure, the system 102 could then open tank supply valve 116 and alert operator to close source valve 120.

Exemplary embodiments of systems and methods for the control of a fire-fighting device are described above in detail. The methods and apparatus are not limited to the specific embodiments described herein, but rather, components of systems and/or steps of the methods may be utilized independently and separately from other components and/or steps described herein. For example, the systems and methods may also be used in combination with other fire-fighting systems and methods, and are not limited to practice with only the fire-fighting device as described herein. Rather, the exemplary embodiment can be implemented and utilized in connection with many other fire-fighting devices.

Although specific features of various embodiments may be shown in some drawings and not in others, this is for convenience only. Moreover, references to “one embodiment” in the above description are not intended to be interpreted as excluding the existence of additional embodiments that also incorporate the recited features. In accordance with the principles of the disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fire-fighting system comprising:
a pump;
a nozzle for directing fluid flow from said pump towards a target area;
a nozzle component coupled to said nozzle, said nozzle component comprising a first transceiver and an indicator;
a fluid line connecting said pump to said nozzle; and
a discharge valve control assembly comprising:
a discharge valve controlling fluid flow between said pump and said nozzle;
a pressure sensor coupled to said fluid line between said pump and said discharge valve; and
a second transceiver providing communication between said nozzle component and said discharge valve control assembly, said discharge valve control assembly configured to:
receive a request to charge a hose section of said fluid line; and
determine whether to open said discharge valve in response to receiving the request based on a fluid pressure detected by said pressure sensor.

2. The fire-fighting system of claim 1, wherein the request to charge the hose section of said fluid line is transmitted from said nozzle component to said discharge valve control assembly by said first transceiver and by said second transceiver.

3. The fire-fighting system of claim 2, wherein said nozzle component further includes a display and an interface, said interface being configured to receive a user-input, wherein said nozzle component transmits the request to charge the hose section of said fluid line in response to receipt of the user-input at the interface.

4. The fire-fighting system of claim 2, wherein said nozzle component is paired to said discharge valve control assembly via communication between said first transceiver and said second transceiver.

5. The fire-fighting system of claim 1, wherein said discharge valve control assembly is communicatively connected to at least one device component of the fire-fighting system, wherein the at least one component includes at least one of a pump control component, a tank sensor coupled to a tank of the fire-fighting system, a source valve actuator, a recirculation valve actuator, and a tank supply valve actuator.

6. The fire-fighting system of claim 5, wherein said discharge valve control assembly is communicatively connected to the one or more device components via a Controller Area Network (“CAN”) of the fire-fighting system.

7. The fire-fighting system of claim 5, wherein said nozzle is a first nozzle, said nozzle component is a first nozzle component, said fluid line is a first fluid line, and said discharge valve assembly is a first discharge valve control assembly, wherein the fire-fighting system further comprises:
a second fluid line connecting said pump to a second nozzle; and
a second discharge valve control assembly, said second discharge valve control assembly being communicatively connected to the at least one device component.

8. The fire-fighting system of claim 7, wherein said first discharge valve control assembly and said second discharge valve control assembly are each directly connected in communication with the at least one device component.

9. The fire-fighting system of claim 7, wherein said second discharge valve control assembly is indirectly connected to the at least one device component through said first discharge valve control assembly.

10. The fire-fighting system of claim 1 further comprising a second pressure sensor coupled between said discharge valve and said nozzle.

11. The fire-fighting system of claim 1, wherein said discharge valve control assembly further comprises a controller including a processor and a memory storing instructions and a predefined pressure limit thereon, wherein said processor is configured to perform the steps of receiving the request to charge said hose section and determining whether to open said discharge valve, wherein said processor is further configured to:
compare the detected fluid pressure to the predefined pressure limit;
if the detected fluid pressure is equal to or exceeds the predefined pressure limit, cause said discharge valve to be opened; and
if the detected fluid pressure is less than the predefined pressure limit, transmit an alert to said nozzle component.

12. A discharge valve control assembly for use with a fire-fighting system, said control assembly comprising:
a discharge valve controlling fluid flow through a fluid line extending from a pump to a nozzle of the fire-fighting system;
a pressure sensor coupled to the fluid line upstream of said discharge valve; and
a transceiver providing communication with a nozzle component coupled to the nozzle, said discharge valve control assembly configured to:
receive a request from the nozzle component to charge a hose section of the fluid line; and
determine whether to open said discharge valve in response to receiving the request based on a fluid pressure detected by said pressure sensor.

13. The discharge valve control assembly of claim 12, wherein said discharge valve control assembly is communicatively connected to at least one device component of the fire-fighting system, the at least one device component including at least one of a pump control component, a tank sensor that detects a level of fluid in a tank of the fire-fighting system, a source valve actuator, a recirculation valve actuator, and a tank supply valve actuator.

14. The discharge valve control assembly of claim 13, wherein said discharge valve control assembly is communicatively connected to an additional discharge valve control assembly of the fire-fighting system, the additional discharge valve control assembly being indirectly connected to the at least one device component through said discharge valve control assembly.

15. The discharge valve control assembly of claim 12 further comprising a processor and a memory storing instructions and a predefined pressure limit thereon, wherein said processor is configured to perform the steps of receiving the request to charge the hose section and determining whether to open said discharge valve, wherein said processor is further configured to:
compare the detected fluid pressure to the predefined pressure limit;
if the detected fluid pressure is equal to or exceeds the predefined pressure limit, cause said discharge valve to be opened; and
if the detected fluid pressure is less than the predefined pressure limit, transmit an alert to the nozzle component.

16. The discharge valve control assembly of claim 12 further comprising a second pressure sensor coupled to the fluid line between said discharge valve and the nozzle.

17. The discharge valve control assembly of claim 12, wherein said discharge valve control assembly is wirelessly paired to the nozzle component.

18. A method of operating a fire-fighting system comprising:
transmitting a first signal from a transceiver at a fire-truck of the fire-fighting system to a nozzle component indicating that a hose section of a fluid line is ready to be charged;
receiving a second signal at the transceiver from the nozzle component, the second signal including a request to charge the hose section;
determining to charge the fluid line based on a fluid pressure detected by a pressure sensor and a predefined minimum pressure stored on a memory, the pressure sensor being positioned on the fluid line upstream of a discharge valve; and
automatically controlling, in response to said determining, the discharge valve to open to charge the hose section.

19. The method of claim 18 further comprising:
detecting a change in state of operation of the fire-truck; and
opening automatically, in response to said detecting, a tank supply valve, the tank supply valve being coupled to a tank supply line extending between a fluid tank and a pump of the fire-fighting system, wherein said transmitting the first signal is automatically performed in response to opening the tank supply valve.

20. The method of claim 18, wherein said second signal includes a user-requested fluid pressure, said method further comprising:
receiving, at a control panel of the fire-truck, a request to change a pressure setting of a pump of the fire-fighting system;
rejecting the request based on a determination that the change to the pressure setting of the pump would provide a fluid pressure to the nozzle that is below the user-requested fluid pressure.
